(19) United States
(12) Patent Application Publication
(10) Pub. No.: US 2026/0223256 A1
(43) Pub. Date: Jul. 30, 2026

(54) INDUCTION HEATING APPARATUS AND METHOD FOR CONTROLLING THE SAME

(71) Applicant: SAMSUNG ELECTRONICS CO., LTD., Suwon-si (KR)

(72) Inventors: Jungyoon HAHM, Suwon-si (KR); Kyounghwan KIM, Suwon-si (KR); Daehyun KIM, Suwon-si (KR); Namju PARK, Suwon-si (KR); Eunsu JANG, Suwon-si (KR); Kyunghoon JUNG, Suwon-si (KR)

(73) Assignee: SAMSUNG ELECTRONICS CO., LTD., Suwon-si (KR)

(21) Appl. No.: 19/630,650

(22) Filed: Mar. 27, 2026

Related U.S. Application Data
(63) Continuation of application No. PCT/KR2025/015270, filed on Sep. 29, 2025.

(30) Foreign Application Priority Data
Oct. 4, 2024 (KR) 10-2024-0135182

(51) Int. Cl. H05B 6/06; H05B 1/02; H05B 6/12; H05B 6/44

(52) U.S. Cl. CPC H05B 6/065; H05B 1/0266; H05B 6/1209; H05B 6/44; H05B 2213/03; H05B 2213/05; H05B 2213/06

(57) ABSTRACT

An induction heating apparatus may include: first heating portions respectively including: a first coil, and a first sensor configured to detect a container at the respective first heating portion; second heating portions respectively including: a second coil, and a second sensor configured to detect the container at the respective second heating portion; an input portion configured to receive a user input including a heating level; a memory that stores a heating output corresponding to the received heating level, and a number of first and/or second heating portions occupied by the container; and a controller configured to: based on data output by the respective first and/or second sensors, determine the number of first and/or second heating portions occupied by the container, and control at least one first heating portion and/or second heating portion occupied by the container to output a heating output corresponding to the stored heating output.

### CROSS-REFERENCE TO RELATED APPLICATIONS

This is a continuation application, under 35 U.S.C. §111(a), of International Application No. PCT/KR2025/015270, filed September 29, 2025, which claims priority under 35 U.S.C. §119 to Korean Patent Application No. 10-2024-0135182, filed October 4, 2024, in the Korean Intellectual Property Office, the disclosures of which are incorporated herein in their entireties by reference.

### TECHNICAL FIELD

The disclosure relates to an induction heating apparatus capable of improving cooking performance, and a method for controlling the same.

### BACKGROUND ART

In general, an induction heating apparatus is a cooking device that heats and cooks food using the principle of induction heating. The induction heating apparatus includes a cooking plate on which a cooking container is placed, and a heating coil that generates a magnetic field when current is applied.

When current is applied to the heating coil and a magnetic field is generated, a secondary current is induced in the cooking container, and Joule heat is generated by the resistance component of the container itself. Accordingly, the cooking container is heated by high-frequency current, and the food contained in the container is cooked.

Because such an induction heating apparatus uses the cooking container itself as a heat source, induction heating apparatuses have higher heat transfer efficiency, no harmful gases, and no risk of fire, compared to gas stoves or kerosene stoves that heat the container through combustion heat of fossil fuels.

However, in an induction heating apparatus, in a case where the cooking container is located on an area where no heating coil is arranged, the container may not be properly heated. In addition, in a case where the temperature of the cooking container is detected and controlled by a single temperature sensor during the cooking process, the temperature of the food may not be maintained properly.

### [Disclosure]

One aspect of the disclosure provides an induction heating apparatus and a method for controlling the same, in which various types of heating coils having different sizes and outputs are arranged on a cooking plate without gaps, thereby increasing the cooking area, and enabling safe and rapid heating output within a predetermined range regardless of the position of the cooking container.

Another aspect of the disclosure provides an induction heating apparatus and a method for controlling the same that may maintain a temperature of food more consistently by detecting the temperature using a plurality of temperature sensors.

Technical aspects that can be achieved by the disclosure are not limited to the above-mentioned aspects, and other technical aspects not mentioned will be clearly understood by one of ordinary skill in the technical art to which the disclosure belongs from the following description.

In accordance with the present disclosure, an induction heating apparatus may include: a plurality of first heating portions that respectively may include: a first coil, and a first sensor configured to detect whether a container occupies the respective first heating portion among the plurality of first heating portions and output data indicating the respective first heating portion is occupied by the container; a plurality of second heating portions that respectively may include: a second coil, and a second sensor configured to detect whether the container occupies the respective second heating portion among the plurality of second heating portions and output data indicating the respective second heating portion is occupied by the container; an input portion configured to receive a user input including a heating level; a memory that stores a heating output corresponding to: the received heating level, and a number of first heating portions occupied by the container and/or a number of second heating portions occupied by the container; and a controller configured to: based on the data output by respective first container sensors and/or the data output by respective second container sensors, determine the number of first heating portions occupied by the container and/or the number of second heating portions occupied by the container, and control at least one first heating portion among the plurality of first heating portions and/or at least one second heating portion among the plurality of second heating portions that are determined to be occupied by the container to output a heating output corresponding to: the received heating level, and the determined number of first heating portions occupied by the container and/or the determined number of second heating portions occupied by the container.

A size of each first heating portion among the plurality of first heating portions may be larger than a size of each second heating portion among the plurality of second heating portions, a maximum heat output of each first heating portion among the plurality of first heating portions may be greater than a maximum heat output of each second heating portion among the plurality of second heating portions, and in response to a stored heating output of the at least one second heating portion corresponding to the received heating level being higher than a maximum heating output of the at least one second heating portion, the controller may be configured to control the at least one first heating portion to allow a heating output of the at least one first heating portion to be higher than a stored heating output of the at least one first heating portion corresponding to the received heating level.

In response to the stored heating output of the at least one second heating portion corresponding to the received heating level being higher than the maximum heating output of the at least one second heating portion, the controller may be configured to control one or more second heating portions among the plurality of second heating portions that are determined to be occupied by the container to allow a heat output of the one or more second heating portions to reach the maximum heat output of each second heating portion.

Based on a determination that the container occupies only one second heating portion among the plurality of second heating portions, the controller may be configured to disable operation of remaining second heating portions among the plurality of second heating portions.

The plurality of first heating portions respectively may include one or more first sensors configured to respectively detect whether the container occupies the first heating portion and output data indicating the first heating portion is occupied by the container, the plurality of second heating portions respectively may include one or more second sensors configured to respectively detect whether the container occupies the second heating portion and output data indicating the second heating portion is occupied by the container, and for each first heating portion among the plurality of first heating portions, based on the container being detected by a first number of the one or more first sensors that may be equal to or greater than a reference number, the controller may be configured to determine that the container occupies the first heating portion , and/or for each second heating portion among the plurality of second heating portions, based on the container being detected by a second number of the one or more second sensors that may be equal to or greater than the reference number, the controller may be configured to determine that the container occupies the second heating portion.

The induction heating apparatus may further include: a first temperature sensor configured to: detect a temperature of the container that occupies the at least one first heating portion among the plurality of first heating portions or the at least one second heating portion among the plurality of second heating portions, and output data indicating the detected container temperature; and a second temperature sensor configured to: detect a temperature of the at least one first heating portion among the plurality of first heating portions or the at least one second heating portion among the plurality of second heating portions, and output data indicating the detected heating portion temperature, wherein the controller may be configured to adjust a heating output of the at least one first heating portion or the at least one second heating portion occupied by the container, based on the detected container temperature and the detected heating portion temperature.

The controller may be configured to reduce the heating output of the at least one first heating portion and/or the at least one second heating portion that is determined to be occupied by the container by a first value, based on the detected container temperature being equal to or greater than a first temperature or the detected heating portion temperature being equal to or greater than a second temperature.

The controller may be configured to reduce the heating output of the at least one first heating portion and/or the at least one second heating portion that is determined to be occupied by the container by a second value greater than the first value, based on the detected container temperature being equal to or greater than a third temperature or the detected heating portion temperature being equal to or greater than a fourth temperature.

Each respective first coil among the plurality of first heating portions and each respective second coil among the plurality of second heating portions may be on a printed circuit board (PCB) substrate.

The induction heating apparatus may further include: a display; wherein the controller may be configured to control the display to display information on a position of the at least one first heating portion among the plurality of first heating portions or the at least one second heating portion among the plurality of second heating portions that are determined to be occupied by the container.

In accordance with the present disclosure, a method for controlling an induction heating apparatus including a plurality of first heating portions respectively including a first coil, and a first sensor configured to detect whether a container occupies the respective first heating portion among the plurality of first heating portions and output data indicating the respective first heating portion is occupied by the container, a plurality of second heating portions respectively including a second coil, and a second sensor configured to detect whether the container occupies the respective second heating portion among the plurality of second heating portions and output data indicating the respective second heating portion is occupied by the container, and an input portion configured to receive a user input including a heating level, a memory that stores a heating output corresponding to: the received heating level, and a number of first heating portions occupied by the container and/or a number of second heating portions occupied by the container, and a controller, the method may include: by the controller, based on the data output by respective first container sensors and/or the data output by respective second container sensors, determining a number of first heating portions occupied by the container and/or a number of second heating portions occupied by the container, based on the heating output stored in the memory, determining a heating output of at least one first heating portion among the plurality of first heating portions and/or at least one second heating portion among the plurality of second heating portions that are determined to be occupied by the container, and controlling the at least one first heating portion among the plurality of first heating portions and/or the at least one second heating portion among the plurality of second heating portions that are determined to be occupied by the container to output the determined heating output.

A size of each first heating portion among the plurality of first heating portions may be larger than a size of each second heating portion among the plurality of second heating portions, a maximum heat output of each first heating portion among the plurality of first heating portions may be greater than a maximum heat output of each second heating portion among the plurality of second heating portions, and the controlling may include, in response to a heating output of the at least one second heating portion corresponding to the received heating level that is stored in the memory being higher than a maximum heating output of the at least one second heating portion, controlling the at least one first heating portion to allow a heating output of the at least one first heating portion to be higher than a heating output of the at least one first heating portion corresponding to the received heating level that is stored in the memory.

The controlling may include, in response to the stored heating output of the at least one second heating portion corresponding to the received heating level being higher than the maximum heating output of the at least one second heating portion, controlling one or more second heating portions among the plurality of second heating portions that are determined to be occupied by the container to allow a heat output of the one or more second heating portions to reach the maximum heat output of each second heating portion.

The controlling may include, based on determining that the container occupies only one second heating portion among the plurality of second heating portions, disabling operation of remaining second heating portions among the plurality of second heating portions.

The plurality of first heating portions respectively may include one or more first sensors configured to respectively detect whether the container occupies the first heating portion and output data indicating the first heating portion is occupied by the container, the plurality of second heating portions respectively may include one or more second sensors configured to respectively detect whether the container occupies the second heating portion and output data indicating the second heating portion is occupied by the container, and for each first heating portion among the plurality of first heating portions, based on the container being detected by a first number of the one or more first sensors that may be equal to or greater than a reference number, determining the number of first heating portions occupied by the container, and/or for each second heating portion among the plurality of second heating portions, based on the container being detected by a second number of the one or more second sensors that may be equal to or greater than the reference number, determining the number of second heating portions occupied by the container.

### DESCRIPTION OF DRAWINGS

FIG. 1 is a view showing a general exterior of an induction heating apparatus.

FIG. 2 and FIG. 3 are views illustrating a general heating principle of an induction heating apparatus.

FIG. 4 is a view showing an exterior of an induction heating apparatus according to an embodiment of the disclosure.

FIG. 5 is a view showing an arrangement of heating portions in the induction heating apparatus according to an embodiment of the disclosure.

FIG. 6 is a view illustrating a printed circuit board (PCB) heating coil according to an embodiment of the disclosure.

FIG. 7 is a control block diagram of the induction heating apparatus according to an embodiment of the disclosure.

FIG. 8 is a flowchart illustrating a control method of the induction heating apparatus according to an embodiment of the disclosure.

FIG. 9 to FIG. 11 show examples of a container placed in various positions on the induction heating apparatus according to an embodiment of the disclosure.

FIG. 12 illustrates types of output corresponding to the heating portions occupied by a container according to an embodiment of the disclosure.

FIG. 13 illustrates heating output corresponding to the types of output and heating levels according to an embodiment of the disclosure.

FIG. 14 is a flowchart illustrating a process of controlling heating output according to an embodiment of the disclosure.

FIG. 15 is a view illustrating a plurality of temperature sensors according to an embodiment of the disclosure.

FIG. 16 and FIG. 17 are flowcharts illustrating a process of controlling heating output according to temperature detection results according to an embodiment of the disclosure.

FIG. 18 is a graph illustrating that a temperature of food is maintained according to an embodiment of the disclosure.

FIG. 19 is a view showing that a position of a container is displayed on a display according to an embodiment of the disclosure.

FIG. 20 is a flowchart illustrating a process of displaying the position of the container on the display according to an embodiment of the disclosure.

### Modes of the Disclosure

The embodiments described in this specification and the configurations shown in the drawings are merely preferred examples of the disclosure, and various modifications may be made at the time of filing of the disclosure to replace the embodiments and drawings of the specification.

Also, the same reference numerals or symbols shown in the drawings of this specification represent parts or components that perform substantially the same functions.

In addition, the terms used in this specification are used only for the purpose of describing the embodiments, and are not intended to limit and/or restrict the disclosure. Unless clearly indicated otherwise in the context, the singular forms also include plural forms. The terms such as “include” or “comprise” used in this specification are intended to specify that certain features, numbers, steps, operations, components, parts, or combinations thereof are present, and do not preclude the possibility of the presence or addition of one or more other features, numbers, steps, operations, components, parts, or combinations thereof.

Further, in this specification, when an element is said to be “connected”, “coupled”, “supported” or “contacted” with another element, this includes not only when elements are directly connected, coupled, supported or contacted, but also when elements are indirectly connected, coupled, supported or contacted through a third element.

Also, ordinal terms such as “first” and “second” used in this specification may be used to describe various components, but such components are not limited by these terms. These terms are only used for distinguishing one component from another. For example, without departing from the scope of the invention, a first component may be referred to as a second component, and similarly, a second component may be referred to as a first component. The term “and/or” includes any and all combinations of one or more of the associated listed items.

Hereinafter, embodiments according to the disclosure will be described with reference to the accompanying drawings.

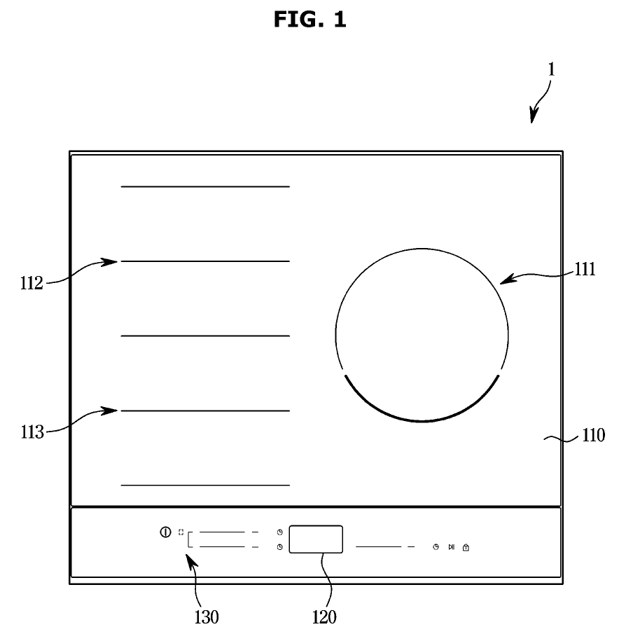

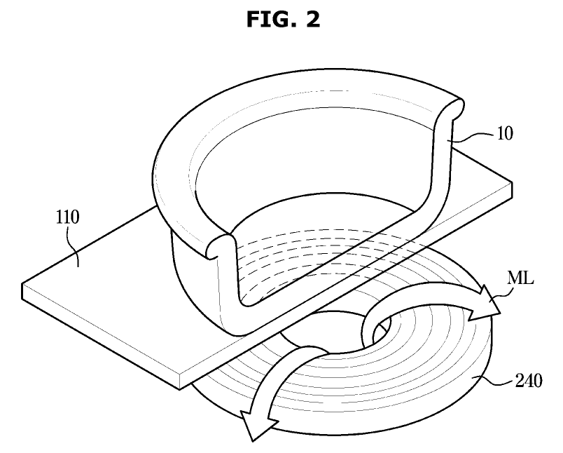

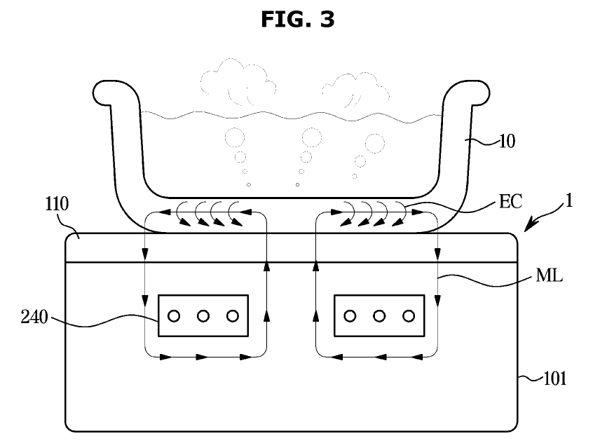

FIG. 1 is a view showing a general external appearance of an induction heating apparatus, and FIG. 2 and FIG. 3 are views illustrating a general heating principle of an induction heating apparatus.

FIG. 1 is a top view of an induction heating apparatus 1 according to an embodiment. As shown in FIG. 1, the induction heating apparatus 1 according to an embodiment may include a plate 110 provided on an upper portion of a main body 101, cooking zones 111, 112, and 113 formed on the plate 110, and user interfaces 120 and 130 functioning as input/output devices. For example, the plate 110 may be implemented using ceramic.

The cooking zones 111, 112, and 113 represent positions on which cooking containers may be placed, and may be indicated in circular form as denoted by reference numeral 111, or in straight boundary lines as denoted by reference numerals 112 and 113 to guide the proper placement of cooking containers.

However, the shapes described above are only examples of the forms for indicating the cooking zones 111, 112, and 113, and any shape that may guide a user to a cooking zone position may be applied to an embodiment of the induction heating apparatus 1, even though the shape is not circular or linear.

In addition, although the illustrated example shows three cooking zones formed on the plate 110, an embodiment of the induction heating apparatus 1 is not limited thereto. Only one cooking zone, or four or more cooking zones may be formed.

A display 120 and an input portion 130 may be provided in one area of the plate 110. The display 120 may include a display device such as a liquid crystal display (LCD) or a light emitting diode (LED), and the input portion 130 may include at least one of various input devices such as a touch pad, button, or jog shuttle. Alternatively, the display 120 and the input portion 130 may be implemented as a touch screen.

In the illustrated example, the display 120 and the input portion 130 are arranged in positions spaced apart from the cooking zones 111, 112, and 113 on the plate 110. However, the arrangement shown in FIG. 1 is merely one example applicable to the induction heating apparatus 1, and the display 120 or the input portion 130 may be disposed at a location other than on the plate 110, such as on the front of the induction heating apparatus 1.

Referring to FIG. 2 and FIG. 3 together, a heating coil 240 used to heat a container 10 placed on the plate 110 may be disposed below the plate 110. Although only one heating coil 240 is shown in FIG. 2 and FIG. 3 for convenience of description, a plurality of heating coils 240 may be provided corresponding in number to the number of cooking zones.

For example, as shown in FIG. 1 where three cooking zones 111, 112, and 113 are provided, three heating coils 240 may also be provided, and each heating coil 240 may be disposed below each of the cooking zones 111, 112, and 113.

Each heating coil 240 may be connected to a resonant circuit and supplied with high-frequency current. For example, the frequency of the high-frequency current may be in the range of 20 kHz to 80 kHz.

When high-frequency current is supplied to the heating coil 240, magnetic lines of force (ML) may be formed. When a container 10 having resistance is positioned within the area affected by the magnetic lines of force (ML), the magnetic lines of force surrounding the heating coil 240 passes through the bottom of the container 10 and generates eddy currents (EC) according to the law of electromagnetic induction.

Due to the interaction between the eddy currents (EC) and the electrical resistance of the container 10, heat may be generated in the container 10, and the food inside the container 10 may be heated by the generated heat.

In the induction heating apparatus 1, because the container 10 itself acts as a heat source, metallic materials having a certain level of resistance, such as iron, stainless steel, or nickel, may be used as the material of the container 10.

Meanwhile, the specifications of the heating coil 240 may be differently designed depending on the rated voltage of the country in which the induction heating apparatus 1 is sold.

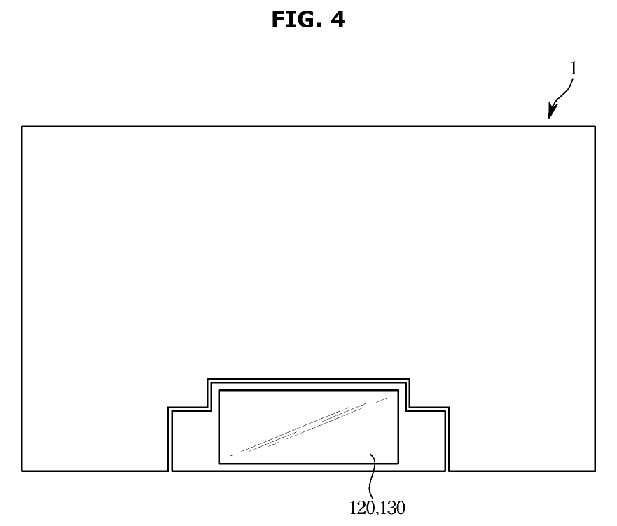

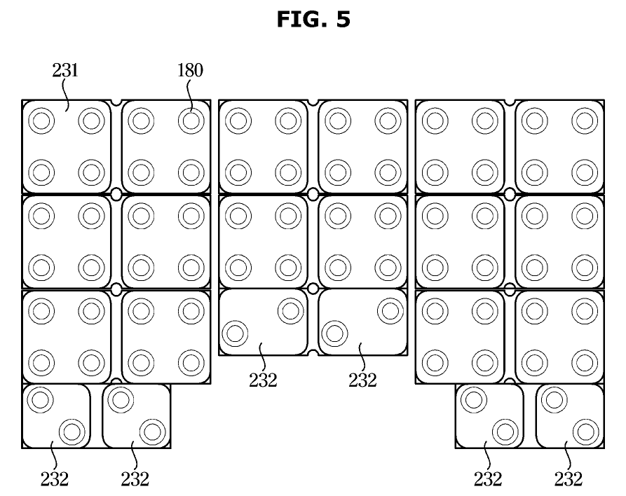

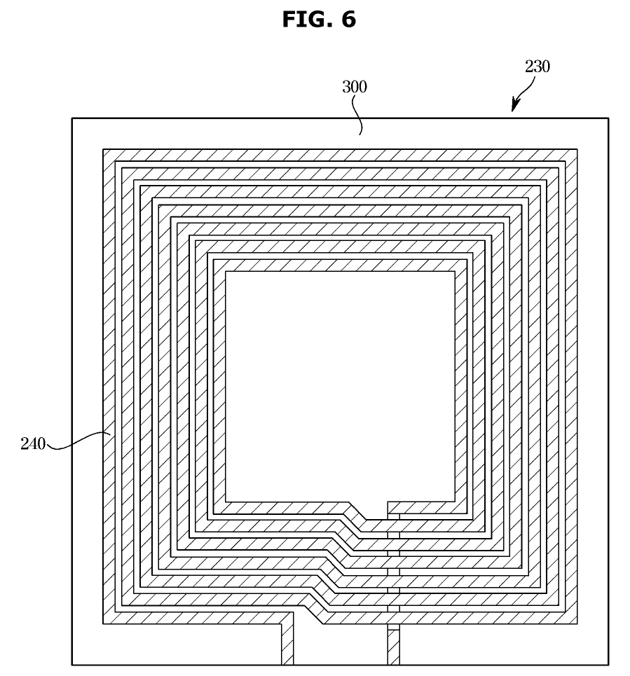

FIG. 4 is a view showing the external structure of the induction heating apparatus according to an embodiment of the disclosure, FIG. 5 shows the arrangement of heating portions in the induction heating apparatus, and FIG. 6 is a view illustrating a printed circuit board (PCB) heating coil.

In an embodiment of the disclosure, the induction heating apparatus 1 may not include any visible indication for cooking zones, as shown in FIG. 4. That is, heating output corresponding to the heating level input by a user may be provided properly regardless of where a container is placed on the cooking plate.

To this end, the heating portions may be arranged as shown in FIG. 5.

First heating portions 231 and second heating portions 232 may be rectangular in shape and arranged below the cooking plate without any gaps. That is, the heating portions may be arranged to fill all areas except the area occupied by the display 120 and the input portion 130 shown in FIG. 4.

Accordingly, the first heating portions 231 and the second heating portions 232 may differ in size and maximum output. For example, the size of the first heating portion 231 may be larger than that of the second heating portion 232, and the maximum output of the first heating portion 231 may also be higher than that of the second heating portion 232.

The first heating portion 231 may include a container sensor 180 for detecting the container and a first coil (not shown), and the second heating portion 232 may include the container sensor 180 and a second coil (not shown).

In a case where the first heating portion 231 is larger than the second heating portion 232, the area occupied by the first coil may also be larger than that of the second coil. Also, the number of container sensors 180 included in the first heating portion 231 may be greater than that in the second heating portion 232. For example, as shown in FIG. 5, the first heating portion 231 may include four container sensors 180, and the second heating portion 232 may include two container sensors 180.

The coils included in the first heating portion 231 and the second heating portion 232 may be disposed on a PCB substrate. That is, the first heating portion 231 and the second heating portion 232 may include sheet coils.

The PCB substrate 300 refers to a printed circuit board, which is a plastic board with copper wiring printed thereon and to which various electronic components such as integrated circuit (IC) chips, resistors, coils, and capacitors are connected.

According to the printed circuit pattern on the PCB substrate 300, the coil 240 as shown in FIG. 6 may be arranged. The coil 240 is typically made of copper, but is not limited thereto.

As shown in FIG. 6, the coil 240 forms a spiral track on the PCB substrate 300 by winding horizontally from the outside toward the inside in multiple turns. Here, a "turn" refers to one loop of the coil 240 as it winds inward. FIG. 6 illustrates an example where the coil 240 forms seven tracks with seven turns. However, the disclosure is not limited thereto, and the coil 240 may be wound without gaps, even in the central area of the PCB substrate 300.

One end of the coil 240 may start winding from the outside to the inside of the PCB substrate 300, and the other end of the coil 240 may extend outward from the center, crossing over the tracks. The ends of the coil 240 may be connected to components such as a capacitor or a resistor.

Hereinafter, various heating operations using the first heating portion 231 and the second heating portion 232 will be described.

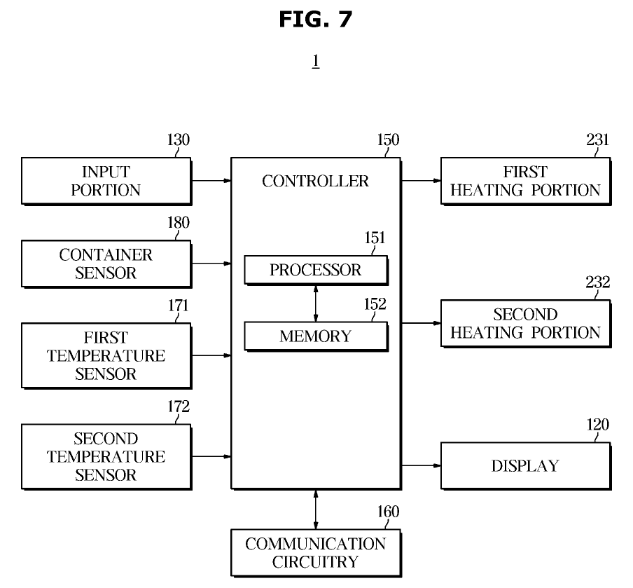

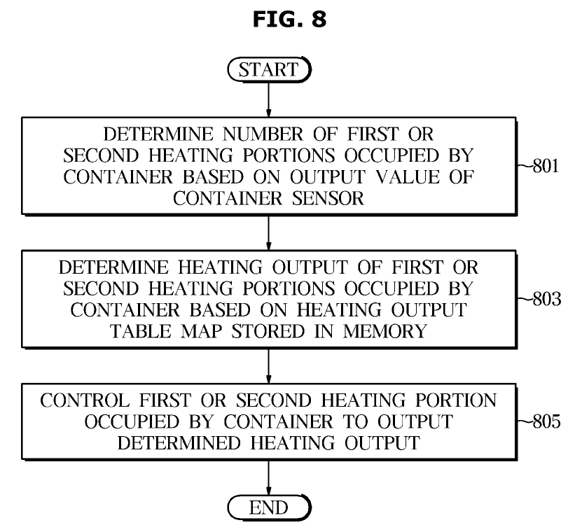

FIG. 7 is a control block diagram of the induction heating apparatus according to an embodiment of the disclosure, and FIG. 8 is a flowchart illustrating a method for controlling the induction heating apparatus according to an embodiment.

The induction heating apparatus 1 of the disclosure may include: the input portion 130 for receiving a heating level setting command for the heating portion 230; the display 120; the container sensor 180 for detecting a container; the first heating portion 231; the second heating portion 232; a first temperature sensor 171 for detecting a temperature of the container; a second temperature sensor 172 for detecting a temperature of the first heating portion 231 or the second heating portion 232; communication circuitry 160; and/or a controller 150. The controller 150 may include at least one processor 151, memory 152, and a resonant circuit (not shown).

The input portion 130 may provide a user interface for interaction between the user and the induction heating apparatus 1.

The input portion 130 may convert sensory information received from the user into electrical signals.

The input portion 130 may include a power button, a heating zone selection button, a heating level setting button, a timer button, etc. At least one input interface 130 may include, for example, a tact switch, push switch, slide switch, toggle switch, micro switch, touch switch, touch pad, touch screen, jog dial, and/or microphone.

The first heating portion 231 and the second heating portion 232 are configured to heat a cooking container and may include at least one heating coil.

These heating portions 230 may operate based on control signals from the controller 150.

In addition, the induction heating apparatus 1 may include communication circuitry for wired and/or wireless communication with external devices.

The communication circuitry 160 may include at least one of a short-range wireless communication module or a long-range wireless communication module.

The communication circuitry 160 may transmit data to or receive data from external devices (e.g., servers, user terminals, or home appliances). For example, the communication circuitry may establish communication with a server and/or a user terminal and/or a home appliance and perform data transmission and reception.

For the communication, the communication circuitry 160 may support the establishment of a direct (e.g., wired) or wireless communication channel with external devices and the performance of communication via the established communication channel. According to an embodiment, the communication circuitry may include a wireless communication module (e.g., a cellular communication module, short-range wireless communication module, or Global Navigation Satellite System (GNSS) communication module) or a wired communication module (e.g., a Local Area Network (LAN) communication module or a power line communication module). The corresponding communication module among these may communicate with an external device via a first network (e.g., a short-range wireless communication network such as Bluetooth, Wi-Fi direct, or infrared data association (IrDA)) or a second network (e.g., a long-range wireless communication network such as a legacy cellular network, 5G network, next-generation communication network, the Internet, or a computer network such as LAN or WAN). These various types of communication modules may be integrated into a single component (e.g., a single chip), or implemented as separate components (e.g., multiple chips).

The short-range wireless communication module may include, but is not limited to, a Bluetooth communication module, a Bluetooth Low Energy (BLE) communication module, a Near Field Communication (NFC) module, a WLAN (Wi-Fi) communication module, a Zigbee communication module, an Infrared Data Association (IrDA) communication module, a Wi-Fi Direct (WFD) communication module, an ultrawideband (UWB) communication module, an Ant+ communication module, and a microwave (uWave) communication module.

The long-range wireless communication module may include communication circuitry for performing various types of long-range wireless communications and may include mobile communication circuitry. The mobile communication circuitry transmits and receives wireless signals with at least one of a base station, an external terminal, and a server over a mobile communication network.

The controller 150 may include the memory 152 that stores a control program and control data for controlling the first heating portion 231 and the second heating portion 232, and the at least one processor 151 that generates a control signal according to the control program and control data stored in the memory 152. The memory 152 and the processor 151 may be provided integrally or separately.

The memory 152 may store programs and data for controlling the first heating portion 231 and the second heating portion 232. In this regard, the memory 152 may store the number of first heating portions 231 or second heating portions 232 occupied by a container and the heating output corresponding to the received heating level. Further details will be described below.

The memory 152 may include volatile memory such as Static Random Access Memory (S-RAM) or Dynamic RAM (D-RAM) for temporarily storing data. The memory 152 may also include non-volatile memory such as Read-Only Memory (ROM), Erasable Programmable ROM (EPROM), or Electrically Erasable Programmable ROM (EEPROM) for long-term storage of data.

The processor 151 may include various logic circuits and arithmetic circuits and may process data based on a program provided from the memory 152 and generate control signals based on the processing result.

In a case where a method according to at least one embodiment of the disclosure includes a plurality of operations, the plurality of operations may be performed by a single processor 151 or by multiple processors 151. For example, when a method according to at least one embodiment performs a first operation, a second operation, and a third operation, all of the first, second, and third operations may be performed by the first processor 151. Alternatively, the first and second operations may be performed by the first processor 151 (e.g., a general-purpose processor), and the third operation may be performed by the second processor 151 (e.g., an artificial intelligence (AI)-specific processor).

The controller 150 may be electrically connected to the input portion 130, the display 120, the first heating portion 231, the second heating portion 232, various sensors (the container sensor 180, the first temperature sensor 171, the second temperature sensor 172), and/or the communication circuitry 160.

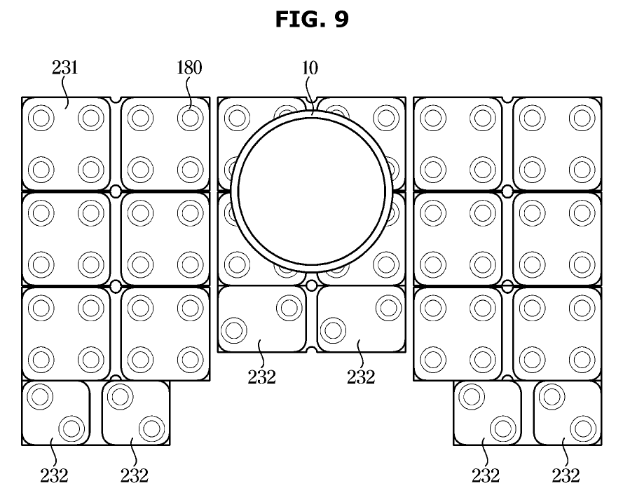

The controller 150 may determine the number of first heating portions 231 or second heating portions 232 occupied by the container 10 based on an output value of the container sensor 180 (operation 801). For example, in a case where the container 10 is placed as shown in FIG. 9, the controller 150 may determine that the container 10 occupies four first heating portions 231.

In determining which heating portions are occupied by the container, in a case where the number of container sensors 180 that detect the container 10 in each heating portion is greater than or equal to a reference number, the controller 150 may determine that the corresponding heating portion is occupied by the container 10.

For example, in a case where the first heating portion 231 includes four container sensors 180 and the container 10 is detected by two or more of the container sensors 180, the controller 150 may determine that the container 10 occupies the corresponding heating portions.

The controller 150 may determine a heating output for the first heating portion 231 or the second heating portion 232 occupied by the container 10 based on a heating output table map stored in the memory 152 (operation 803), and may control the first heating portion 231 or the second heating portion 232 to output (apply) the determined heating output to the heating portions occupied by the container 10 (operation 805).

### Further details are described below.

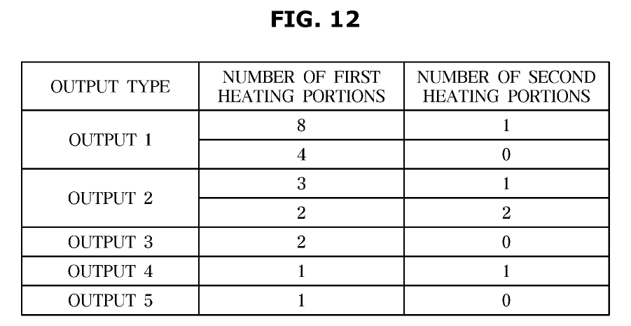

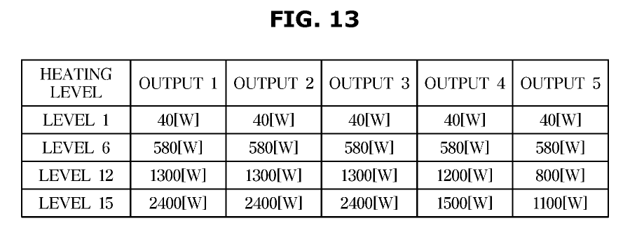

FIG. 9 to FIG. 11 show examples of a container placed in various positions on the induction heating apparatus according to an embodiment of the disclosure. FIG. 12 illustrates types of output corresponding to the heating portions occupied by the container, and FIG. 13 illustrates heating outputs corresponding to output types and heating levels.

In the example shown in FIG. 9, when the container 10 is placed as illustrated, the controller 150 may determine that the container 10 occupies four first heating portions 231.

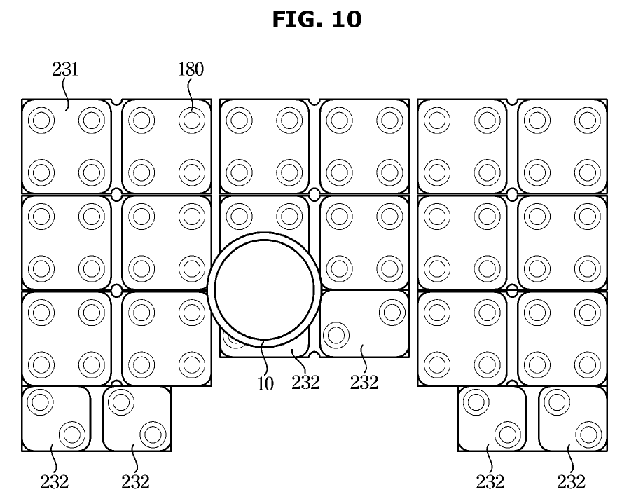

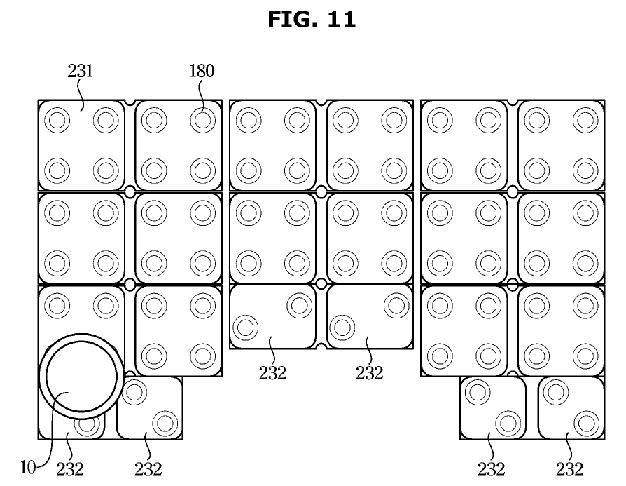

In the example shown in FIG. 10, the controller 150 may determine that the container 10 occupies one first heating portion 231 and one second heating portion 232. In the example shown in FIG. 11, the controller 150 may determine that the container 10 occupies one first heating portion 231 and one second heating portion 232.

In each of the above cases, the controller 150 may determine the type and number of heating portions occupied by the container 10 and may control the first heating portion 231 and the second heating portion 232 to output the corresponding heating output based on a table map stored in the memory 152.

The memory 152 may store the number of first heating portions 231 or second heating portions 232 occupied by the container 10, and the heating output corresponding to a received heating level.

That is, the memory 152 may store a table map that matches different heating output types depending on the type and number of heating portions occupied by the container 10 as shown in FIG. 12, and store another table map that associates the output types with heating outputs corresponding to heating levels input by the user.

In the case shown in FIG. 9, where the container 10 is determined to occupy four first heating portions 231, the output type may be designated as "Output 1".

In this case, when the user inputs a heating level of 1, the controller 150 may control the four first heating portions 231 occupied by the container 10 to output 40 [W],and when the user inputs a heating level of 12, the controller 150 may control the four first heating portions 231 occupied by the container 10 to output 1300 [W].

In the case where the container 10 is placed as shown in FIG. 10 or FIG. 11, it may be determined that the container 10 occupies one first heating portion 231 and one second heating portion 232, and the output type may be designated as "Output 4".

In this case, when the user inputs a heating level of 1, the controller 150 may control the one first heating portion 231 and the one second heating portion 232 occupied by the container 10 to output 40 [W]. In addition, when the user inputs a heating level of 12, the controller 150 may control the one first heating portion 231 and the one second heating portion 232 occupied by the container 10 to output 1200 [W].

As described above, the size and maximum output of the second heating portion 232 may be smaller than those of the first heating portion 231. Accordingly, when the number of second heating portions 232 occupied by the container 10 is relatively greater and the number of first heating portions 231 occupied by the container 10 is relatively smaller, the heating output at the same heating level may be lower.

On the other hand, because the size and maximum output of the second heating portion 232 are relatively small, based on determining that the container 10 occupies only the second heating portion 232, the heating operation may not be performed.

Hereinafter, an example of adjusting an output of each heating portion to allow each heating portion to output the determined heating output will be described.

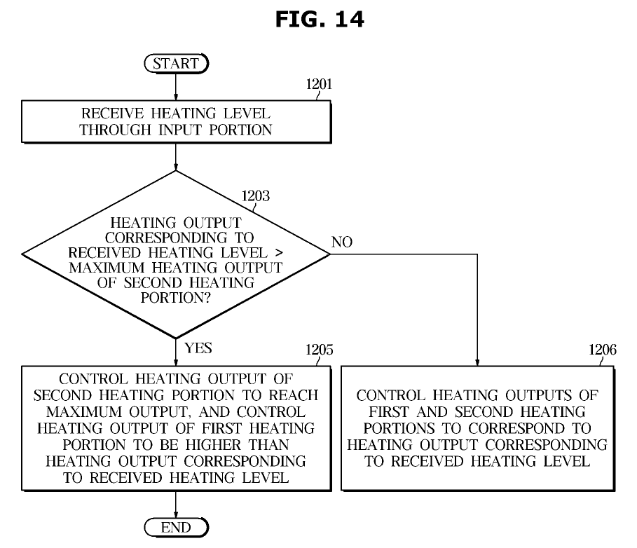

FIG. 14 is a flowchart illustrating a process of controlling heating output according to an embodiment of the disclosure.

A heating output corresponding to a heating level received via the input portion (operation 1201) may exceed a maximum output of the second heating portion 232 (Yes in operation 1203). In this case, the controller 150 may control the first heating portion 231 occupied by the container 10 such that a heating output of the first heating portion 231 is higher than the heating output corresponding to the received heating level, and may control the second heating portion 232 such that a heating output of the second heating portion 232 becomes the maximum output (operation 1205).

Hereinafter, a case will be described in which the container 10 occupies one first heating portion 231 and one second heating portion 232, as illustrated in FIG. 10.

For example, it is assumed that the heating output corresponding to the user-input heating level is 800 [W], the maximum output of the first heating portion 231 is 1000 [W], and the maximum output of the second heating portion 232 is 500 [W].

In this case, because the maximum output of the second heating portion 232 is lower than the 800 [W] corresponding to the heating level input by the user, the second heating portion 232 may be controlled to output the maximum output of 500 [W], and the first heating portion 231 may be controlled to output more than 800 [W], thereby achieving a heating output close to 800 [W].

Based on the heating output corresponding to the heating level received via the input portion being lower than the maximum output of the second heating portion 232 (No in operation 1203), the controller 150 may control the heating outputs of both the first heating portion 231 and the second heating portion 232 to correspond to the heating output corresponding to the received heating level (operation 1206).

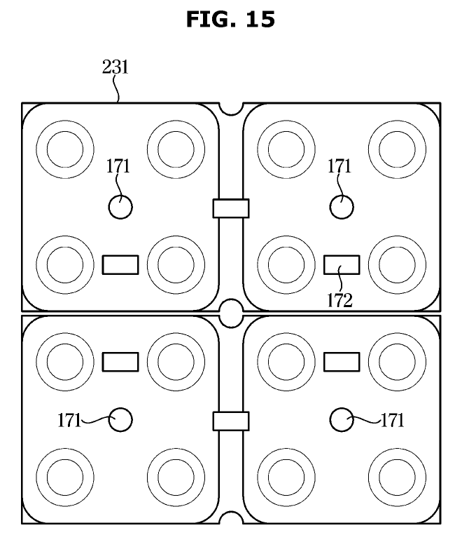

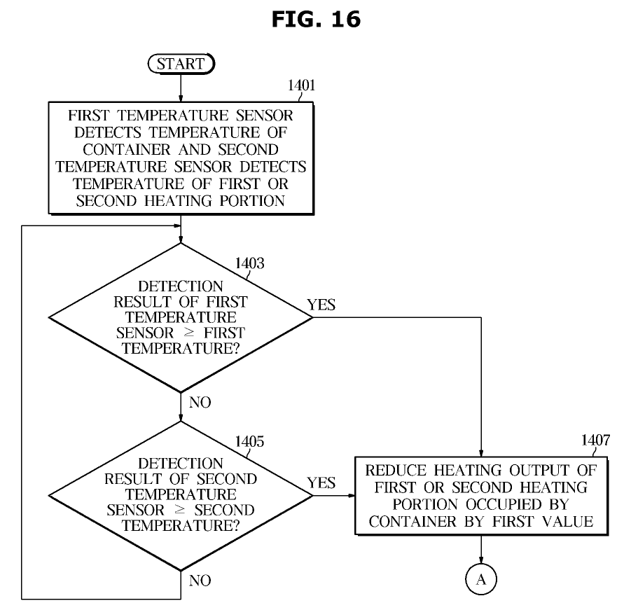

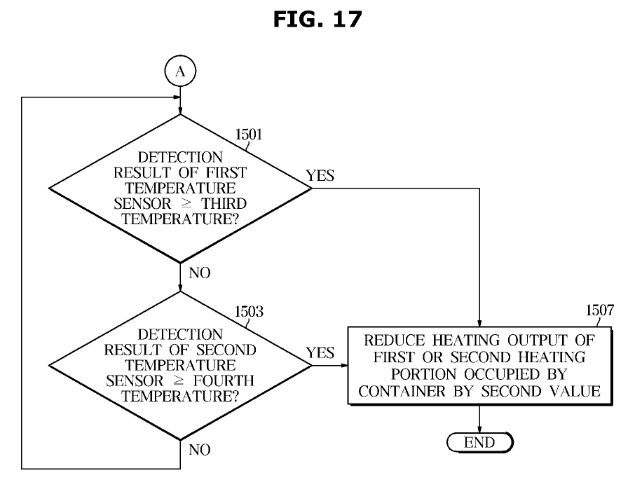

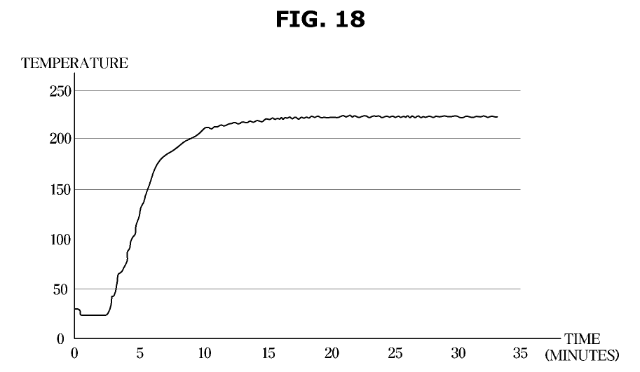

FIG. 15 is a view for illustrating a plurality of temperature sensors according to an embodiment of the disclosure. FIG. 16 and FIG. 17 are flowcharts illustrating processes for adjusting heating output based on temperature detection results, and FIG. 18 is a graph illustrating that a temperature of food is maintained.

As described above, the induction heating apparatus 1 may include the first temperature sensor 171 for detecting a temperature of a container and the second temperature sensor 172 for detecting a temperature of a heating portion.

The first temperature sensor 171 may detect the temperature of the container 10 occupying the heating portion, and the second temperature sensor 172 may detect the temperature of the heating portion occupied by the container 10.

As shown in FIG. 15, the first temperature sensor 171 may be disposed in the center of each heating portion to detect the temperature of the container 10 occupying the heating portion.

The second temperature sensor 172 may be disposed at the edge of the heating portion or between heating portions to detect the temperature of the heating portion occupied by the container 10.

The controller 150 may change the heating output of the first heating portion 231 or the second heating portion 232, occupied by the container 10, based on the detection results of the first and second temperature sensors 171 and 172.

In a case where oil inside the container 10 is heated and requires to be maintained at a constant temperature, using only one temperature sensor may lead to deviations in temperature due to various sources of error, causing the oil temperature to rise or fall undesirably.

To address the above, a plurality of temperature sensors, i.e., both the first temperature sensor 171 and the second temperature sensor 172, may be used, and when either sensor detects that a reference temperature has been reached, the heating output may be reduced to maintain a more stable oil temperature.

Specifically, the controller 150 may reduce the heating output of the first heating portion 231 or the second heating portion 232 occupied by the container 10 by a first value (operation 1407), based on the detection result (operation 1401) from the first temperature sensor 171 being equal to or greater than a first temperature (Yes in operation 1403), or the detection result (operation 1401) from the second temperature sensor 172 being equal to or greater than a second temperature (Yes in operation 1405).

Here, the first value, the first temperature, and the second temperature may be appropriately set to maintain the contents inside the container. For example, the first temperature may be 168 °C and the second temperature may be 120 °C.

Thereafter, based on the detection result from the first temperature sensor 171 being equal to or greater than a third temperature (Yes in operation 1501), or the detection result from the second temperature sensor 172 being equal to or greater than a fourth temperature (Yes in operation 1503), the controller 150 may reduce the heating output of the first heating portion 231 or the second heating portion 232 occupied by the container 10 by a second value (operation 1507).

The second value, the third temperature, and the fourth temperature may also be set to appropriate values to maintain the contents inside the container. For example, the third temperature may be 170 °C and the fourth temperature may be 123 °C.

Thus, by reducing the heating output based on either temperature sensor detecting that the reference temperature has been reached, the oil temperature may be stably maintained, as shown in FIG. 18.

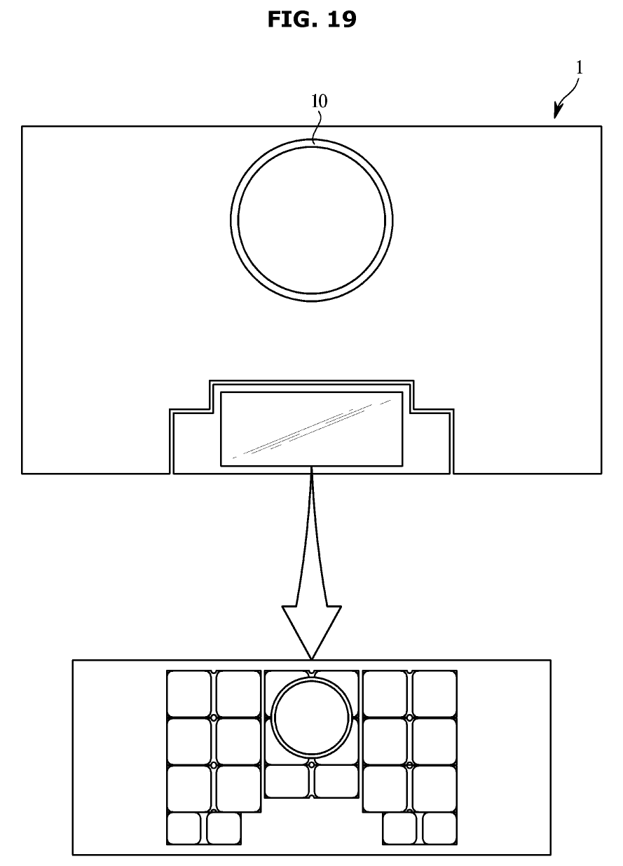

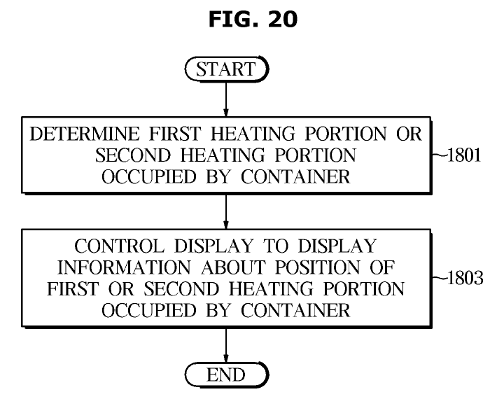

FIG. 19 is a diagram illustrating that a position of a container is displayed on the display according to an embodiment of the disclosure, and FIG. 20 is a flowchart illustrating a process of displaying the position of the container on the display according to an embodiment of the disclosure.

The controller 150 may determine the first heating portion 231 or the second heating portion 232 occupied by the container 10 (operation 1801), and control the display 120 to display information about the position of the first heating portion 231 or the second heating portion 232 occupied by the container 10 (operation 1803).

As shown in FIG. 4, because the upper plate of the induction heating apparatus 1 according to the disclosure does not include a separate indication to guide the cooking zone, a user may not accurately recognize where the container 10 is placed.

To address the above, the position where the container 10 is placed may be provided via the display 120, allowing the user to accurately identify the location of the container 10.

According to an embodiment of the disclosure, an induction heating apparatus may include: a plurality of first heating portions including a first coil and a container sensor configured to detect a container; a plurality of second heating portions including a second coil and a container sensor configured to detect the container; an input portion configured to receive input on a heating level from a user; a memory configured to store a heating output corresponding to a number of first or second heating portions occupied by the container and the received heating level; and a controller configured to: determine the number of first or second heating portions occupied by the container based on an output value of the container sensor, and control at least one of the plurality of first heating portions or at least one of the plurality of second heating portions occupied by the container to output a heating output corresponding to the number of first or second heating portions occupied by the container and the heating level.

According to the disclosure, PCB-type heating coils having different sizes and outputs may be arranged on a cooking plate without any gaps, thereby increasing the cooking area, and enabling safe and rapid heating output within a predetermined range regardless of the position of the cooking container.

A size and a maximum output of each of the first heating portions may be greater than a size and a maximum output of each of the second heating portions, and in response to the heating output corresponding to the received heating level being higher than a maximum heating output of the second heating portion, the controller may be configured to control the at least one of the plurality of first heating portions occupied by the container to allow a heating output of the at least one first heating portion to be higher than the heating output corresponding to the received heating level.

In response to the heating output corresponding to the received heating level being higher than the maximum heating output of the second heating portion, the controller may be configured to control the at least one of the plurality of second heating portions occupied by the container to allow a heating output of the at least one second heating portion to reach the maximum output.

Based on determining that the container occupies only at least one of the plurality of second heating portions, the controller may be configured to disable an operation of the at least one second heating portion.

The plurality of first heating portions and the plurality of second heating portions may each include a defined number of container sensors, and based on the container being detected by a number of container sensors equal to or greater than a reference number among the defined number of container sensors, the controller may be configured to determine that the container occupies the at least one of the plurality of first heating portions or the at least one of the plurality of second heating portions that may include container sensors in a number equal to or greater than the reference number.

The induction heating apparatus may further include a first temperature sensor configured to detect a temperature of the container occupying the at least one of the plurality of first heating portions or the at least one of the plurality of second heating portions; and a second temperature sensor configured to detect a temperature of the at least one of the plurality of first heating portions or the at least one of the plurality of second heating portions, wherein the controller may be configured to adjust a heating output of the at least one first heating portion or the at least one second heating portion occupied by the container, based on detection results of the first temperature sensor and the second temperature sensor.

According to the disclosure, the induction heating apparatus may maintain the temperature of food more consistently by using a plurality of temperature sensors to detect the temperature.

The controller may be configured to reduce the heating output of the at least one first heating portion or the at least one second heating portion occupied by the container by a first value, based on the detection result of the first temperature sensor being equal to or greater than a first temperature or the detection result of the second temperature sensor being equal to or greater than a second temperature.

The controller may be configured to reduce the heating output of the at least one first heating portion or the at least one second heating portion occupied by the container by a second value greater than the first value, based on the detection result of the first temperature sensor being equal to or greater than a third temperature or the detection result of the second temperature sensor being equal to or greater than a fourth temperature.

Each of the first coil and the second coil may be arranged on a printed circuit board (PCB) substrate.

The induction heating apparatus may further include a display, wherein the controller may be configured to control the display to display information on a position of the at least one of the plurality of first heating portions or the at least one of the plurality of second heating portions occupied by the container.

According to an embodiment of the disclosure, in a method for controlling an induction heating apparatus including a plurality of first heating portions including a first coil and a container sensor configured to detect a container, a plurality of second heating portions including a second coil and a container sensor configured to detect the container, and an input portion configured to receive input on a heating level from a user, the method may include: determining a number of first or second heating portions occupied by the container based on an output value of the container sensor; determining a heating output of at least one of the plurality of first heating portions or at least one of the plurality of second heating portions occupied by the container, based on a heating output corresponding to the number of first or second heating portions and the received heating level, the heating output being stored in a memory; and controlling the at least one of the plurality of first heating portions or the at least one of the plurality of second heating portions occupied by the container to output the determined heating output.

A size and a maximum output of each of the first heating portions may be greater than a size and a maximum output of each of the second heating portions, and the controlling of the at least one of the plurality of first heating portions or the at least one of the plurality of second heating portions may include, in response to the heating output corresponding to the received heating level being higher than a maximum heating output of the second heating portion, controlling the at least one of the plurality of first heating portions occupied by the container to allow a heating output of the at least one first heating portion to be higher than the heating output corresponding to the received heating level.

The controlling of the at least one of the plurality of first heating portions or the at least one of the plurality of second heating portions may include, in response to the heating output corresponding to the received heating level being higher than the maximum heating output of the second heating portion, controlling the at least one of the plurality of second heating portions occupied by the container to allow a heating output of the at least one second heating portion to reach the maximum output.

The controlling of the at least one of the plurality of first heating portions or the at least one of the plurality of second heating portions may include, based on determining that the container occupies only at least one of the plurality of second heating portions, disabling an operation of the at least one second heating portion.

The plurality of first heating portions and the plurality of second heating portions may each include a defined number of container sensors, and based on the container being detected by a number of container sensors equal to or greater than a reference number among the defined number of container sensors, the determining of the number of first or second heating portions occupied by the container may include determining that the container occupies the at least one of the plurality of first heating portions or the at least one of the plurality of second heating portions that may include container sensors in a number equal to or greater than the reference number.

The induction heating apparatus may further include a first temperature sensor configured to detect a temperature of the container occupying the at least one of the plurality of first heating portions or the at least one of the plurality of second heating portions; and a second temperature sensor configured to detect a temperature of the at least one of the plurality of first heating portions or the at least one of the plurality of second heating portions, and the method may further include adjusting a heating output of the at least one first heating portion or the at least one second heating portion occupied by the container, based on detection results of the first temperature sensor and the second temperature sensor.

The adjusting of the heating output of the at least one first heating portion or the at least one second heating portion may include reducing the heating output of the at least one first heating portion or the at least one second heating portion occupied by the container by a first value, based on the detection result of the first temperature sensor being equal to or greater than a first temperature or the detection result of the second temperature sensor being equal to or greater than a second temperature.

The adjusting of the heating output of the at least one first heating portion or the at least one second heating portion may include reducing the heating output of the at least one first heating portion or the at least one second heating portion occupied by the container by a second value greater than the first value, based on the detection result of the first temperature sensor being equal to or greater than a third temperature or the detection result of the second temperature sensor being equal to or greater than a fourth temperature.

Each of the first coil and the second coil may be arranged on a printed circuit board (PCB) substrate.

The induction heating apparatus may further include a display, and the method may further include controlling the display to display information on a position of the at least one of the plurality of first heating portions or the at least one of the plurality of second heating portions occupied by the container.

According to the disclosure, PCB-type heating coils having different sizes and outputs may be arranged on a cooking plate without any gaps, thereby increasing the cooking area, and enabling safe and rapid heating output within a predetermined range regardless of the location of the cooking container.

Furthermore, by detecting a temperature using a plurality of temperature sensors, the temperature of food may be more consistently maintained.

Meanwhile, the disclosed embodiments may be implemented in the form of a recording medium storing computer-executable instructions. The instructions may be stored in the form of program code, and when executed by a processor, may generate program modules to perform operations of the disclosed embodiments. The recording medium may be implemented as a computer-readable recording medium.

The computer-readable recording medium includes all types of recording media on which instructions interpretable by a computer are stored. Examples include read-only memory (ROM), random access memory (RAM), magnetic tapes, magnetic disks, flash memory, and optical data storage devices.

As described above, the disclosed embodiments have been described with reference to the accompanying drawings. However, it will be understood by those skilled in the art that the disclosure may be implemented in other forms without changing the technical spirit or essential characteristics of the disclosure. The disclosed embodiments should be considered illustrative and not restrictive.

1. An induction heating apparatus, comprising:
a plurality of first heating portions respectively including:
a first coil, and
a first sensor configured to detect whether a container occupies the respective first heating portion among the plurality of first heating portions and output data indicating the respective first heating portion is occupied by the container;
a plurality of second heating portions respectively including:
a second coil, and
a second sensor configured to detect whether the container occupies the respective second heating portion among the plurality of second heating portions and output data indicating the respective second heating portion is occupied by the container;
an input portion configured to receive a user input including a heating level;
a memory that stores a heating output corresponding to:
the received heating level, and
a number of first heating portions occupied by the container and/or a number of second heating portions occupied by the container; and
a controller configured to:
based on the data output by respective first container sensors and/or the data output by respective second container sensors, determine the number of first heating portions occupied by the container and/or the number of second heating portions occupied by the container, and
control at least one first heating portion among the plurality of first heating portions and/or at least one second heating portion among the plurality of second heating portions that are determined to be occupied by the container to output a heating output corresponding to:
the received heating level, and
the determined number of first heating portions occupied by the container and/or the determined number of second heating portions occupied by the container.

2. The induction heating apparatus of claim 1, wherein
a size of each first heating portion among the plurality of first heating portions is larger than a size of each second heating portion among the plurality of second heating portions,
a maximum heat output of each first heating portion among the plurality of first heating portions is greater than a maximum heat output of each second heating portion among the plurality of second heating portions, and
in response to a stored heating output of the at least one second heating portion corresponding to the received heating level being higher than a maximum heating output of the at least one second heating portion, the controller is configured to control the at least one first heating portion to allow a heating output of the at least one first heating portion to be higher than a stored heating output of the at least one first heating portion corresponding to the received heating level.

3. The induction heating apparatus of claim 2, wherein, in response to the stored heating output of the at least one second heating portion corresponding to the received heating level being higher than the maximum heating output of the at least one second heating portion, the controller is configured to control one or more second heating portions among the plurality of second heating portions that are determined to be occupied by the container to allow a heat output of the one or more second heating portions to reach the maximum heat output of each second heating portion.

4. The induction heating apparatus of claim 1, wherein, based on a determination that the container occupies only one second heating portion among the plurality of second heating portions, the controller is configured to disable operation of remaining second heating portions among the plurality of second heating portions.

5. The induction heating apparatus of claim 1, wherein
the plurality of first heating portions respectively include one or more first sensors configured to respectively detect whether the container occupies the first heating portion and output data indicating the first heating portion is occupied by the container,
the plurality of second heating portions respectively include one or more second sensors configured to respectively detect whether the container occupies the second heating portion and output data indicating the second heating portion is occupied by the container, and
for each first heating portion among the plurality of first heating portions,
based on the container being detected by a first number of the one or more first sensors that is equal to or greater than a reference number, the controller is configured to determine that the container occupies the first heating portion , and/or
for each second heating portion among the plurality of second heating portions,
based on the container being detected by a second number of the one or more second sensors that is equal to or greater than the reference number, the controller is configured to determine that the container occupies the second heating portion.

6. The induction heating apparatus of claim 1, further comprising:
a first temperature sensor configured to:
detect a temperature of the container that occupies the at least one first heating portion among the plurality of first heating portions or the at least one second heating portion among the plurality of second heating portions, and
output data indicating the detected container temperature; and
a second temperature sensor configured to:
detect a temperature of the at least one first heating portion among the plurality of first heating portions or the at least one second heating portion among the plurality of second heating portions, and
output data indicating the detected heating portion temperature,
wherein the controller is configured to adjust a heating output of the at least one first heating portion or the at least one second heating portion occupied by the container, based on the detected container temperature and the detected heating portion temperature.

7. The induction heating apparatus of claim 6, wherein the controller is configured to reduce the heating output of the at least one first heating portion and/or the at least one second heating portion that is determined to be occupied by the container by a first value, based on the detected container temperature being equal to or greater than a first temperature or the detected heating portion temperature being equal to or greater than a second temperature.

8. The induction heating apparatus of claim 7, wherein the controller is configured to reduce the heating output of the at least one first heating portion and/or the at least one second heating portion that is determined to be occupied by the container by a second value greater than the first value, based on the detected container temperature being equal to or greater than a third temperature or the detected heating portion temperature being equal to or greater than a fourth temperature.

9. The induction heating apparatus of claim 1, wherein each respective first coil among the plurality of first heating portions and each respective second coil among the plurality of second heating portions is on a printed circuit board (PCB) substrate.

10. The induction heating apparatus of claim 1, further comprising:
a display;
wherein the controller is configured to control the display to display information on a position of the at least one first heating portion among the plurality of first heating portions or the at least one second heating portion among the plurality of second heating portions that are determined to be occupied by the container.

11. A method for controlling an induction heating apparatus including a plurality of first heating portions respectively including a first coil, and a first sensor configured to detect whether a container occupies the respective first heating portion among the plurality of first heating portions and output data indicating the respective first heating portion is occupied by the container, a plurality of second heating portions respectively including a second coil, and a second sensor configured to detect whether the container occupies the respective second heating portion among the plurality of second heating portions and output data indicating the respective second heating portion is occupied by the container, and an input portion configured to receive a user input including a heating level, a memory that stores a heating output corresponding to: the received heating level, and a number of first heating portions occupied by the container and/or a number of second heating portions occupied by the container, and a controller, the method comprising:
by the controller,
based on the data output by respective first container sensors and/or the data output by respective second container sensors, determining a number of first heating portions occupied by the container and/or a number of second heating portions occupied by the container,
based on the heating output stored in the memory, determining a heating output of at least one first heating portion among the plurality of first heating portions and/or at least one second heating portion among the plurality of second heating portions that are determined to be occupied by the container, and
controlling the at least one first heating portion among the plurality of first heating portions and/or the at least one second heating portion among the plurality of second heating portions that are determined to be occupied by the container to output the determined heating output.

12. The method of claim 11, wherein
a size of each first heating portion among the plurality of first heating portions is larger than a size of each second heating portion among the plurality of second heating portions,
a maximum heat output of each first heating portion among the plurality of first heating portions is greater than a maximum heat output of each second heating portion among the plurality of second heating portions, and
the controlling includes, in response to a heating output of the at least one second heating portion corresponding to the received heating level that is stored in the memory being higher than a maximum heating output of the at least one second heating portion, controlling the at least one first heating portion to allow a heating output of the at least one first heating portion to be higher than a heating output of the at least one first heating portion corresponding to the received heating level that is stored in the memory.

13. The method of claim 12, wherein the controlling includes, in response to the stored heating output of the at least one second heating portion corresponding to the received heating level being higher than the maximum heating output of the at least one second heating portion, controlling one or more second heating portions among the plurality of second heating portions that are determined to be occupied by the container to allow a heat output of the one or more second heating portions to reach the maximum heat output of each second heating portion.

14. The method of claim 11, wherein the controlling includes, based on determining that the container occupies only one second heating portion among the plurality of second heating portions, disabling operation of remaining second heating portions among the plurality of second heating portions.

15. The method of claim 11, wherein
the plurality of first heating portions respectively include one or more first sensors configured to respectively detect whether the container occupies the first heating portion and output data indicating the first heating portion is occupied by the container,
the plurality of second heating portions respectively include one or more second sensors configured to respectively detect whether the container occupies the second heating portion and output data indicating the second heating portion is occupied by the container, and
for each first heating portion among the plurality of first heating portions,
based on the container being detected by a first number of the one or more first sensors that is equal to or greater than a reference number, determining the number of first heating portions occupied by the container, and/or
for each second heating portion among the plurality of second heating portions,
based on the container being detected by a second number of the one or more second sensors that equal to or greater than the reference number, determining the number of second heating portions occupied by the container.
